(19) United States
(12) Patent Application Publication
(10) Pub. No.: US 2010/0198630 A1
(43) Pub. Date: Aug. 5, 2010

(54) SUPPLIER RISK EVALUATION

(75) Inventors: Gary Francis Page, Concord, NC (US); Mary Frances Edwards, Charlotte, NC (US); Kevin Michael Woerner, Charlotte, NC (US); Kellie Lyn McCorvey, Fort Mill, SC (US)

Correspondence Address: MOORE & VAN ALLEN, PLLC FOR BOFA, 430 DAVIS DRIVE, SUITE 500, POST OFFICE BOX 13706, RESEARCH TRIANGLE PARK, NC, 27709, US

(73) Assignee: BANK OF AMERICA CORPORATION, Charlotte, NC (US)

(21) Appl. No.: 12/362,964

(22) Filed: Jan. 30, 2009

(51) Int. Cl. G06Q 10/00

(52) U.S. Cl. 705/7

(57) ABSTRACT

Evaluating the risks posed by a supplier of goods and services, wherein the supplier subcontracts the production of the goods or services to a third entity, offshores the production of the goods or services, or uses an offshore subcontractor to provide the goods or services. In at least some embodiments, the invention comprises gathering answers to a series of multiple choice questions regarding characteristics of the goods or services provided by the supplier and calculating a risk score therefrom. An embodiment can be implemented via a stand-alone computing system or such a system interconnected with other platforms or data stores by a network, such as a corporate intranet, a local area network, or the Internet.

### CROSS-REFERENCE TO RELATED APPLICATIONS

At least some of what is disclosed in this application is also disclosed in U.S. patent application Ser. No. ______, entitled, “Supplier Portfolio Indexing,” and U.S. patent application Ser. No. ______, entitled, “Supplier Stratification,” both of which were filed in even date herewith, are commonly assigned, and are incorporated herein by reference.

### BACKGROUND

Operation of a successful business today requires the ability to collaborate with companies throughout the world. Further, oftentimes today's businesses are of such a complex nature that numerous suppliers of goods and services are utilized by a single business. To further complicate matters, many providers of goods and services are so complex that they also require collaborative efforts with other businesses in order to meet their own customers' needs. All together, this creates a hierarchy of multiple levels of interactivity that are required just to meet daily logistical needs and keep a business running smoothly.

Risk is an important factor to be considered whenever any kind of interaction is implemented between a contracting business and a supplier. Risk factors that are of particular concern when contracting with suppliers of goods and services include any factors that could expose a business to loss or theft, as suppliers often have direct access to proprietary business systems and information. Businesses therefore tend to expend valuable resources managing and mitigating risk factors inherent to supplier relationships. However, such resources tend to be allocated subjectively and don't tend to take into account all of the factors that may play into a multi-faceted contractor-supplier relationship. Instead, traditional approaches to management of risk posed by suppliers focus on the amount of money spent with a particular supplier, and perhaps also on regulatory requirements that must be met when working with a supplier.

Complications and risks may arise at two primary levels for businesses contracting with suppliers for goods and services. First, the nature of the interaction may be such that the supplier must subcontract with third parties in order to meet a contractor's needs, putting risk management and mitigation one step removed from the direct reach of the contractor. Second, a supplier may be required to utilize services offered by businesses outside of the country in which the contract between the contractor and the supplier was executed, again negatively impacting the contracting business's ability to manage and mitigate risk.

### SUMMARY

Embodiments of the present invention provide a method and system of evaluating risks posed by a supplier of goods and services, wherein the supplier subcontracts the production of the goods or services to a third entity, offshores the production of the goods or services, or uses an offshore subcontractor to provide the goods or services. In at least some embodiments, a risk score is calculated for the supplier based on answers to a series of multiple choice questions.

In at least some embodiments, there are at least ten multiple choice questions included in the evaluation. In some embodiments, there are at least eleven multiple choice questions included in the evaluation. In some embodiments, there are at least twelve multiple choice questions included in the evaluation.

In at least some embodiments, the answer options for at least some of the multiple choice questions are each assigned a weighted risk value, which is used in calculating the risk score for the supplier.

In at least some embodiments, the risk factors measured comprise how the supplier risk is mitigated and how the supplier is managed. Risk factors that measure how the supplier risk is mitigated and how the supplier is managed comprise insurance requirement factors, background check factors, audit factors, confidentiality and information protection factors, business continuity factors, and efforts to manage or mitigate risk factors.

In at least some embodiments, the risk factors measured comprise providing a listing of countries from which is selected each country in which production of goods or services for the contractor will occur. A weighted risk value is assigned to each country, wherein the weighted value is representative of the risk posed by working in that country.

In at least some embodiments, the risk factors measured comprise providing a listing of the goods or services to be provided by the supplier who is at least subcontracting or offshoring goods or services to be provided under the contract with the contractor, from which is selected each good or service to be provided by the supplier. A weighted risk value is assigned to each good or service.

In at least some embodiments, the risk factors measured comprise a listing of which of the goods or services are to be provided by the at least one subcontractor or the at least one offshore affiliate.

In at least some embodiments, the risk factors measured comprise a determination of whether the at least one subcontractor or the at least one offshore affiliate is critical to the production of the goods or services provided to the contractor.

In at least some embodiments, the risk factors measured comprise identifying each subcontractor or offshore affiliate by name.

In at least some embodiments, the risk factors measured comprise determining the subcontractor's or offshore affiliate's level of access to the contractor's information systems and/or physical properties. In some embodiments, the risk factors measured comprise determining the frequency of the subcontractor's or offshore affiliate's access to the contractor's information systems and/or physical properties.

In some embodiments, the invention is implemented via either a stand-alone instruction execution platform or such a platform interconnected with other platforms or data stores by a network, such as a corporate intranet, a local area network, or the Internet. A computer program product or computer program products contain computer programs with various instructions to cause the hardware to carry out, at least in part, the methods and processes of the invention. Data sets may comprise risk factor data, risk value data, and data for determining supplier risk score. Data sets may be stored locally or accessed over a network. Dedicated software can be provided to implement the invention, or alternatively, a spreadsheet program can be used to implement embodiments of the invention. In either case a user screen is operable to receive appropriate input and to provide output.

### BRIEF DESCRIPTION OF THE DRAWINGS

FIG. 1 is a flow chart that illustrates a method of using embodiments of the invention.

FIG. 2 is a system block diagram according to example embodiments of the invention.

### DETAILED DESCRIPTION OF THE INVENTION

The present invention will now be described in terms of specific, example embodiments. It is to be understood that the invention is not limited to the example embodiments disclosed. It should also be understood that not every feature of the systems and methods described is necessary to implement the invention as claimed in any particular one of the appended claims. Various elements, stages, processes, and features of various embodiments of systems, apparatus, and processes are described in order to fully enable the invention. It should also be understood that throughout this disclosure, where a process or method is shown or described, the steps of the method may be performed in any order or simultaneously, unless it is clear from the context that one step depends on another being performed first. Also, time lags between steps can vary.

The present invention can be embodied in computer software or a computer program product. An embodiment may include a spreadsheet program and may also include appropriate macro programs, algorithms, or plug-ins. An embodiment may also consist of a custom-authored software application for any of various computing platforms. One specific example discussed herein involves the use of a Windows™ personal computing platform running Microsoft Excel™ spreadsheet software. It cannot be overemphasized that this embodiment is an example only. It will also be readily understood that the inventive concepts described herein can be adapted to any type of hardware and software platform using any operating system including those based on Unix™ and Linux. In any such embodiments, the instruction execution or computing platform in combination with computer program code instructions form the means to carry out the processes of the invention.

Embodiments of the present invention provide a method and system of evaluating risks posed to a business by a supplier of goods or services, wherein the supplier subcontracts the production of the goods or services to a third entity, offshores the production of the goods or services, or uses an offshore subcontractor to provide the goods or services. A risk score is calculated and is used to drive risk mitigation and management of the supplier. The risk score is calculated from answers to a series of multiple choice questions, wherein the multiple choice questions are used to establish risk factors associated with the supplier.

The following description is based on an exemplary implementation of an embodiment of the invention in a financial institution, but it is understood that the present invention could be useful in many different types of businesses and the example herein is not intended to limit the use of the invention to any particular industry. The term “financial institution” refers to an institution that acts as an agent to provide financial services for its clients or members. Financial institutions generally, but not always, fall under financial regulation from a government authority. Financial institutions include, but are not limited to, banks, building societies, credit unions, stock brokerages, asset management firms, savings and loans, money lending companies, insurance brokerages, insurance underwriters, dealers in securities, and similar businesses.

In summary, and as an exemplary embodiment, supplier risk evaluation (SRE) is described in more detail as follows. A business, sometimes referred to herein as a contractor, often enters into contracts with other business entities for the purpose of purchasing goods and services. SRE is applicable in situations in which the production of goods and services occurs outside of the supplier's direct control, management, and oversight, such as use of a subcontractor or an offshore affiliate. Such situations are inherently risky for the contractor, as the actual production of goods and services is removed from the entity with which they entered into contractual agreement.

In some embodiments, the risk score is aligned to the monetary value associated with the risk, but it is understood by one of skill in the art that the risk score may be aligned to any factor(s) seen to be potentially harmful to the business. In at least some embodiments, the risk score comprises a sum of risk values across defined risk categories, measured by use of a series of multiple choice questions. In one embodiment, the risk score comprises a sum of risk values measured across ten risk categories. In another embodiment, the risk score comprises a sum of risk values measured across eleven risk categories. In a further embodiment, the risk score comprises a sum of risk values measured across twelve risk categories. The term “risk” refers to the probability that there will be a loss to the business. The loss may be a direct financial loss. The loss may also be nonfinancial on its face, such as damage to the business's reputation amongst customers.

Evaluation of the risks posed by a supplier of goods and services requires input in the form of answers to a series of multiple choice questions. The multiple choice questions provide a simple interface between the user and the sophisticated risk analysis underlying the multiple choice questions. Each question has multiple answer options that are each assigned a risk value, wherein the risk values fall within a predetermined value range, for example within a range of 0-100 inclusive, or within a range of 0-9 inclusive. The purpose of weighting the answer options for each question within the same predetermined value range is to normalize the output. An inverted scoring logic is implemented, so that a larger risk value correlates with lower risk. Based on the answers to the questions, SRE provides a risk score indicative of the overall risk posed by the specific supplier for the goods and services to be supplied by that supplier.

SRE provides output in the form of graphs and tables. The output is objective, and is provided in numerical data formats that enable direct comparison of the risks posed by different suppliers. For example, the risk score is a number that can be meaningfully compared between suppliers. SRE output also provides guidance for managing the supplier and mitigating risks posed by the supplier. Specifically, SRE allows the user to look at the overall risk score, which is an aggregate of all of the risk factors examined, or allows the user to disaggregate the overall risk score and look at the specific risk factors which pose the highest risk, thereby enabling focused risk management and mitigation efforts.

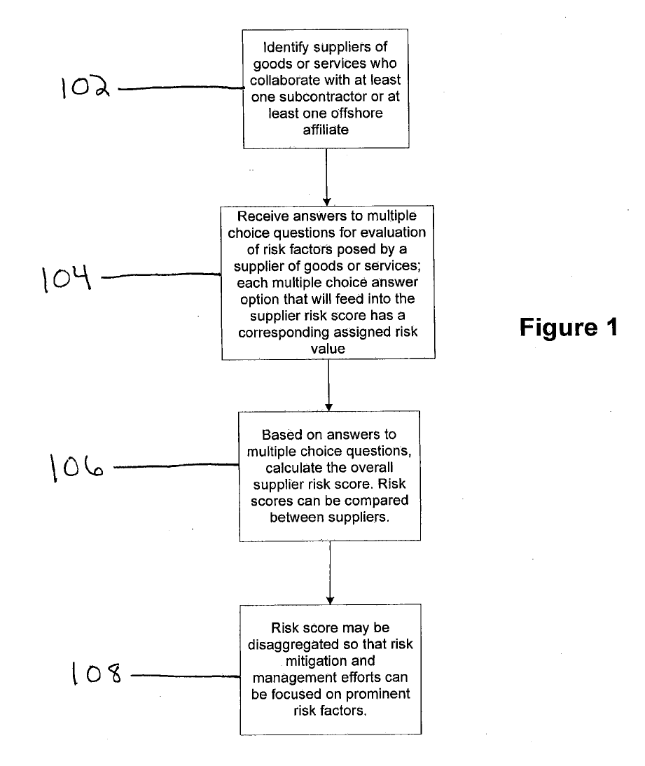

FIG. 1 is a flow chart depicting an overview of the SRE process in at least some embodiments. The user first answers a binary (yes or no) question that identifies whether a supplier of goods or services collaborates with at least one subcontractor or at least one offshore affiliate 102. If the answer to the initial question is no, there is no further evaluation of that supplier. If the answer to the initial question is yes, then the user continues to answer a series of multiple-choice questions that serve as a risk assessment for the supplier 104. The multiple choice questions provide measurements for a plurality of risk factors, wherein each risk factor that will be included in the calculation of the supplier risk score is assigned a weighted value. The user is guided through the series of questions, the answers to which result in a risk score calculated specifically for that supplier and the goods or services to be provided by the supplier 106. The risk score is calculated by taking the sum of all of the weighted values corresponding to the selected answer options. The risk score is a normalized value that allows risk scores calculated for different suppliers to be directly compared in a meaningful way.

Finally, the risk score can be disaggregated so that risk mitigation and management efforts can be focused on prominent risk factors 108. Disaggregation enables a user to determine which risk factors were assigned the highest risk values for the supplier and thus it is possible to see the proportional impact of each risk factor on the overall risk score. Knowing which risk factors have the highest impact on the risk score enables focused risk mitigation and supplier management efforts that directly address the most severe risk factors associated with a particular supplier.

The following example presents SRE as it is applied in some embodiments of the invention. SRE is used to determine whether a supplier poses risks, associated with its subcontractors and offshore affiliates, to the business with which it contracted. As used here, the term “contractor” is used to refer to the primary business that has entered into a contractual agreement with a “supplier” for goods or services. A “supplier” is a business that provides goods or services. A “subcontractor” is an entity hired by a supplier. A subcontractor does not have a direct contractual agreement with the contractor. An “offshore affiliate” is an entity hired or used by a supplier that is located in a country other than that in which the contract between the contractor and the supplier was executed. An offshore affiliate does not have a direct contractual agreement with the contractor. An offshore affiliate may be, for example, a wholly owned subsidiary of the supplier, or may be a completely separate third party business. An offshore affiliate that is a completely separate entity from the supplier is also a subcontractor, and thus may pose risks associated with both subcontracting and offshoring.

When a supplier or user on behalf of a supplier initiates SRE, the first question (Q1) asks whether the supplier is subcontracting or offshoring any goods or services related to the contract with the contractor, which in this example is a financial institution. This is a yes or no question, with a weighted assigned risk value of 0 for yes and 100 for no. If the answer to this initial question is no, the supplier is not required to answer any further questions within SRE. The supplier's overall risk score is therefore 100, which indicates that there is no subcontracting or offshoring risk associated with the supplier.

If the supplier's answer to the initial question is yes, the supplier is required to answer the rest of the multiple choice questions. In some embodiments, including the examples herein, SRE comprises twelve questions. In some embodiments, SRE may comprise ten multiple choice questions. In some embodiments, SRE may comprise eleven multiple choice questions. One of skill in the art will understand that the number of questions, as well as the content of the questions, may differ without changing the scope of the invention as described herein.

The second question (Q2) asks how the supplier is managing and monitoring the subcontractor(s) or offshoring affiliate(s) to insure compliance to the terms and conditions of the contract with the contractor, which in this case is a financial institution. This question has six answer options, each of which is assigned a weighted risk value of 0 (highest risk), 5, or 9 (lowest risk). The six answer options and corresponding risk values are Insurance Requirements (with a risk value of 5), Background Checks (with a risk value of 5), Audits (with a risk value of 9), Confidentiality and Information Protection (with a risk value of 5), Business Continuity (with a risk value of 5), and None (with a risk value of 0). In many cases, a supplier will find only one of these answer options applicable. However, in some embodiments a plurality of these measures may be applicable to the supplier, and in such cases, the risk value assigned to this question will default to the selected answer option providing the highest risk value (which corresponds to the lowest number, since SRE uses inverted scoring logic). Thus, the overall risk score reflects a conservative assessment of risk. It is understood by one of skill in the art that the factors influencing contract compliance will differ with the nature of the contract, and that these factors can be tailored to fit a specific contract.

The third question (Q3) asks in what countries the subcontractor(s) or offshore affiliates(s) will be performing work for the contractor, or financial institution. This question draws data from a table listing countries and their corresponding risk values, which are in the range of 0-9 inclusive. The supplier can select as many answer options as are applicable to this question, so there may be a plurality of answer options selected by a single supplier. SRE then defaults to the selected answer option providing the highest risk value, again supporting a conservative assessment of risk as reflected in the overall risk score, as the highest risk value applicable to the Q3 risk factor is the one that is used in the risk score calculation.

The table that provides lists of countries and their corresponding risk values for Q3 may be provided by a source outside of SRE, as such information may be useful in other applications as well. In one embodiment, the table may be maintained by the financial institution for its own internal use in various areas of business. In another embodiment, the table may be obtained from another source or industry, such as the insurance industry. Each country in the table is assigned a country risk rating based on a plurality of attributes, wherein a high country risk rating corresponds to a high risk. The country risk ratings are placed within a range of 1-99 inclusive; most countries have a rating that falls between 1 and 9 inclusive.

Attributes considered when assigning a country risk rating may include, but are not limited to, financing attributes, ratings by financial research and analysis institutions, investment securities, equity investments, underwriting loans and securities, and total traded products. Additional factors such as geopolitical risk, civil unrest risk, currency fluctuation, educational levels and unemployment/employment levels are also determinants of the risk associated with doing business in any given country. The country risk rating is assigned within a range of 1-9. The one risk rating that may fall outside the 1-9 range is that assigned to a country to which subcontracting or offshoring is not allowed with SRE. These so-called “forbidden” countries are assigned a risk rating of 99. The country risk rating is then converted to a risk value, which is a value normalized within SRE. The conversion occurs by a simple inversion of the values on a scale of 1-9. There is an element of subjectivity involved in assigning the country risk score, as well as recognition that risk changes over time. Because risk fluctuates, the country risk scores are periodically re-evaluated and potentially may change annually.

Any country that is not listed on the country risk rating table is assigned a country risk rating of 9, which reflects a relatively high risk and converts to a risk value of 1 within SRE. As noted above, some countries are assumed to be of such high risk that no subcontracting or offshoring to them is allowed by SRE. Such countries (for example, the Russian Federation) are assigned a country risk rating of 99, which converts to a risk value of 0 and represents maximum risk. For these forbidden countries, the supplier or user cannot proceed any further with SRE. The risk involved is considered to be so high that it cannot be mitigated or managed effectively.

The fourth question (Q4) asks for the name of subcontractor(s) or offshore affiliate(s) identified above. The name of each subcontractor or offshore affiliate is listed individually. In at least some embodiments, the names may be provided in a dropdown menu to insure consistency in naming. In some embodiments, the subcontractors and offshore affiliates are tracked to see if they are used by multiple suppliers, as the contractor's risk increases when subcontractors or offshore affiliates are relied on by a plurality of suppliers. The contractor can thus use this information to determine risk posed by an individual subcontractor or offshore affiliate used by multiple suppliers. In the exemplary embodiment presented herein, Q4 does not contribute a risk value to the overall risk score calculated for an individual supplier.

The fifth question (Q5) asks what goods or services are provided by the subcontractor(s) or offshore affiliate(s) that are related to the contract with the contractor. Some of the answer option data for this question are provided by a commodity risk table, which comprises a list of goods, each with a corresponding risk potential value. The risk potential value is 1, 5, or 9, wherein a low number represents a low risk and a high number represents a high risk. This number is converted to a weighted risk value by maintaining the values as 1, 5, or 9 but inverting them so that a low number represents a high risk and a high number represents a low risk. This conversion normalizes the commodity risk value so that it is meaningful within SRE. For example, the commodity “mortgage services” is assigned a commodity risk potential of 9, representing high risk. Services are purchases involving personnel performing a function that the contractor either chooses not to do themselves (outsourcing) or cannot perform due to lack of a core competency in performing the function. Goods are material items produced using either raw materials or components to create a new or value added product. The corresponding SRE risk value for mortgage services is 1. As in some of the other questions, more than one Q5 answer option may be applicable to a single supplier, but the option correlated with the highest level of risk will be included in the scoring. Again, this approach insures a conservative risk measurement.

Services are assigned a risk value by the person completing the survey. If more than one answer option is selected, SRE will default to the answer tool of high or low in the fifth question, corresponding to a risk value of either 1 or 9 with 1 being a high risk score and 9 being the lowest possible score.

Answers to Q5 are separated into the two categories of goods and services. The risk value corresponding to the answer option with the highest level of risk is the one utilized in each category, if there is at least one good and at least one service provided by the supplier. A supplier may supply at least one good, at least one service, or at least one good and at least one service. Any of these three options can be reflected in the answer options selected for Q5.

The sixth question (Q6) asks whether, based on the supplier's response to question 5 above, the good(s) or service(s) to be provided by the supplier under the contract are provided by a subcontractor, an offshore affiliate or both. Just as is suggested by the wording of the question, there are three answer options for this question, each with an assigned risk value. The answer options are Subcontractor (with a risk value of 1), Offshore Affiliate (with a risk value of 5), and Both (which is a subcontractor performing the work offshore, and for which the risk value is 1).

The seventh question (Q7) asks whether the subcontractor(s) or offshore affiliate(s) are critical to the good(s) or service(s) provided to the contractor. The term “critical” refers to any good or service necessary for maintaining the daily operations of the contractor. Critical operations are those that are necessary for maintaining the daily operations of the contractor. In other words, if the product or service was unavailable, operations would cease within a 48 hour period. There are two answer options for Q7, each with an assigned risk value. The answer options are Yes (with a risk value of 5) and No (with a risk value of 9).

The eighth question (Q8) asks whether the subcontractor(s) or offshore affiliate(s) have access to information belonging to the contractor or financial institution as defined herein. The term “information” as used herein refers to any information, such as facts or data, used by the contractor in its daily operations. The information may be proprietary to the contractor. For example, the information may be maintained on various systems internal to the contractor, such as computer systems, internet systems, intranet systems, LAN systems, or paper filing systems. One of skill in the art will understand that the type of information, or how the information is stored and maintained, is not meant to limit the scope of the present invention. There are two answer options for Q8, each with an assigned risk value. The answer options are Yes (with a risk value of 5) and No (with a risk value of 9).

The ninth question (Q9) asks whether contractor information resides on the subcontractor's or offshore affiliate's systems. Q8 and Q9 together provide a two-tiered examination of (a) whether a subcontractor or offshore affiliate has access to the contractor's information, and (b) whether that access occurs within the confines of the contractor's secured system or whether the subcontractor or offshore affiliate maintains information on their own systems external to the contractor. There are two answer options for Q9, each with an assigned risk value. The answer options are Yes (with a risk value of 5) and No (with a risk value of 9).

The tenth question (Q10) is a two-part question. The first part asks whether the service(s) provided include the exchange of contractor information, with Yes (with a risk value of 5) and No (with risk value of 9) answer options. If the answer to the first part of Q10 is yes, then the supplier is asked for the frequency of contractor information exchange. The answer options include Daily (with a risk value of 1), Weekly (with a risk value of 1), Monthly (with a risk value of 1), Quarterly (with a risk value of 5), and Annually (with a risk value of 5).

The eleventh question (Q11) asks whether the subcontractor(s) or offshore affiliate(s) have connectivity to the contractor's systems. The answer options for Q11 are Yes (with a risk value of 5) and No (value of 9). The term “connectivity” as used herein refers to the requirement of establishing a direct connection with the contractor, particularly a connection between computers or computer systems and establishing the free flow of data from one computer to another without benefit or necessity of human intervention to effect the exchange.

The twelfth question (Q12) asks whether the subcontractor(s) have access to the contractor's physical property on a regular basis. The answer options for Q12 are Yes (with a risk value of 5) and No (with a risk value of 9). In the present example, the question asks whether the subcontractor(s) have unrestricted badge access to the contractor's physical property on a regular basis. As used herein the term “unrestricted badge access” refers to the same freedom of access as that assigned to an employee of the contractor.

Once the twelve questions have been answered, the supplier risk score can be tallied. This is done by simply adding up all of the risk values that resulted from the answer options selected for the twelve questions. Again, since SRE uses inverted scoring logic, a low score represents high risk and a high score represents low risk. A score of 0 represents the lowest possible score and a risk so high that the transaction will not be approved, such as a supplier offshoring to the Russian Federation (which has a country risk rating of 99). A score of 100 is the lowest possible risk and the highest possible score, and is only assigned to a supplier who does no subcontracting or offshoring.

For risk scores other than a 0 or a 100, the risk score can be disaggregated so that the risk factors contributing the highest level of risk can be determined. In one embodiment, a user can simply view each of the risk values resulting from the answers to the questions and note which one(s) indicate the highest level of risk.

It is understood that the examples of inputs, outputs, and user screens discussed herein are intended as examples of how SRE may be presented during use and are not meant to be limiting. One of skill in the art would understand that many different presentations of the SRE feature are possible. For example, one of skill in the art would recognize that in some embodiments, the risk scores may be graphed or presented in a table or spreadsheet format for comparison between suppliers. In some embodiments, the components of the disaggregated risk score may be presented in a graph, or in a table or spreadsheet format.

The answer options for multiple choice questions Q2, Q3, and Q5-Q12 are weighted by being assigned a risk value. In the inverted scoring logic used in the embodiments of the invention described herein, a lower risk value correlates to increased risk. A higher value correlates to decreased risk. One of skill in the art will appreciate that not only may the multiple choice questions differ, but the answer options, risk values, and scoring logic may also differ yet still be meaningful and within the scope of the present invention. Q1 and Q4 are also multiple choice questions, and the answer options for Q1 are also assigned weighted values. However, Q1 is weighted to the same scale as the overall risk score tallied from the values assigned to the answers selected for Q2, Q3, and Q5-Q12. The selected answer options for Q4 feed into a measurement used in assessment of risk posed by individual subcontractors and offshore affiliates.

In order to create a normalizing effect, the answer options for questions Q2, Q3, and Q5-Q12 are assigned a risk value within a predetermined value range. In the example embodiments herein, the range is 0-9, inclusive. In the present example, the risk values are assigned as noted above in the descriptions of the questions. It is understood by those of skill in the art that the numerical values of the range may be adjusted and the invention will still function, so long as all questions used in the risk score calculation are normalized to the selected scale.

Questions Q1 and Q4 are exceptions to the 0-9 risk value range. Q1 offers two answer options: Yes (with a value of 0) or No (with a value of 100). As was noted above, Q1 is set to the same value range as the overall risk score. The result of this scoring system is that a supplier who does not use subcontractors or offshore affiliates receives a perfect “no-risk” score of 100. In contrast, a supplier who uses subcontractors or offshore affiliates receives a score of 0 and then proceeds to answer the ten questions, each of which has a value range of 0-9. The answer options for Q4 are not assigned a risk value and do not directly add to the calculation of the risk score.

Exemplary embodiments of the present invention, using SRE to calculate a risk score for a supplier, will now be described. In one example, the supplier (hereinafter referred to as S1) provides the following answers to SRE multiple choice questions. For Q1, S1 selects answer option yes, which is assigned a risk value of 0. This indicates that S1 uses at least one subcontractor or at least one offshore affiliate, and so will proceed with the rest of the SRE questions. For Q2, S1 selects answer option Audit, which is assigned a risk value of 9. For Q3, S1 selects answer option Israel, which has a country risk rating of 6. When the country risk rating is converted to a SRE risk value by inversion of the 1-9 scale, it becomes a 4. For Q4, S1 provides the answer GNC Corp., which is not assigned a risk value. For Q5, S1 selects answer option Charitable, which is assigned a service risk level of low and a commodity risk rating of 1 on the Commodity Risk table, which converts to a risk value of 9. For Q6, S1 selects answer option Subcontractor, which is assigned a risk value of 1. For Q7, S1 selects answer option Yes, which is assigned a risk value of 5. For Q8, S1 selects answer option No, which is assigned a risk value of 9. For Q9, S1 selects answer option No, which is assigned a risk value of 9. For Q10, S1 selects answer option No to the question of whether the subcontractor or offshore affiliate service includes an exchange of the contractor's information. The answer option No is assigned a risk value of 9. Because S1 answered no to the first part of this two-part question, S1 is not required to provide an answer to the second part of Q10, which addresses the frequency of the information exchange. For Q11, S1 selects answer option No, which is assigned a risk value of 9. For Q12, S1 selects answer option No, which is assigned a risk value of 9.

The risk values, generated by the answers to the multiple choice questions, are added together to provide an overall risk score for S1. Therefore, the risk score for S1=0+9+4+9+1+5+9+9+9+9+9=73. A risk score of 73 indicates that supplier S1 poses an acceptable level of risk to the contractor.

Even though the risk posed by S1 is quite low, disaggregation of the risk score for S1 may provide further information regarding the best approaches for managing and mitigating the risk posed to the business by working with S1. In some embodiments, disaggregation may be conducted by simply looking for the lowest risk values contributing to the risk score, since low risk values indicate high levels of risk. Disaggregation of the risk score for S1 indicates that the biggest risk factor is simply the fact that a subcontractor is used by S1 for production of a good or service to be provided under the contract with the contractor. This is represented by Q6, which has a risk value of 1 as answered by S1. The next biggest risk factor appears to be the country in which the subcontractor or offshore affiliate would conduct work (Q3, which is Israel with a risk value of 4). Thus, in the case of S1, it doesn't appear that much more refinement of the supplier tracking system is needed beyond normal monitoring procedures.

In a second example, the supplier (hereinafter referred to as S2) provides the following answers to the SRE multiple choice questions. For Q1, S2 selects answer option yes, which is assigned a risk value of 0. This indicates that S2 uses at least one subcontractor or at least one offshore affiliate, and so will proceed with the rest of the SRE questions. For Q2, S2 selects answer option Background Checks, which is assigned a risk value of 5. For Q3, S2 selects answer option India, which has a country risk rating of 5. When the country risk rating is converted to a SRE risk value by inversion of the 1-9 scale, it is still a 5. For Q4, S2 provides the answer Saphire, which is not assigned a risk value. For Q5, S2 selects answer option Check Orders, which is assigned a service risk level of low and a commodity risk rating of 9 on the Commodity Risk table, which converts to a risk value of 1. For Q6, S2 selects answer option Subcontractor, which is assigned a risk value of 1. For Q7, S2 selects answer option Yes, which is assigned a risk value of 5. For Q8, S2 selects answer option Yes, which is assigned a risk value of 5. For Q9, S2 selects answer option Yes, which is assigned a risk value of 5. For Q10, S2 selects answer option Yes to the question of whether the subcontractor or offshore affiliate service includes an exchange of the contractor's information. The answer option Yes is assigned a risk value of 5. Because S2 answered yes to the first part of this two-part question, S2 is required to provide an answer to the second part of Q10, which addresses the frequency of the information exchange. For the second part of Q10, S1 selects answer option Daily, which is assigned a risk value of 1. Note that a risk value of 1 for Q10 is therefore used in calculating the risk score for S2, because for questions for which there are multiple answers selected, SRE defaults to the risk value representative of the highest level of risk. For Q11, S2 selects answer option Yes, which is assigned a risk value of 5. For Q12, S2 selects answer option Yes, which is assigned a risk value of 5.

The risk values, generated by the answers to the multiple choice questions, are added together to provide an overall risk score for S2. Therefore, the risk score for S2=0+5+5+1+1+5+5+5+1+5+5=38. A risk score of 38 indicates that supplier S2 poses what would probably be considered an acceptable level of risk to the contractor, but the risk posed by S2, with a risk score of 38, is significantly higher than that posed by S1, with a risk score of 73.

S2 has a risk score indicative of a high enough risk level to warrant a closer look for determining how best to reduce, mitigate, or manage the risk. Disaggregation of the risk score for S2 may provide further information regarding the best approaches for managing and mitigating risk. In this example, disaggregation may be conducted by simply looking for the lowest risk values contributing to the risk score, since low risk values indicate high levels of risk. Disaggregation of the risk score for S2 indicates that there are three risk factors that deserve a closer look. The first is the answer to Q6, as noted above, which contributes a high level of risk simply because S2 collaborates with a least one contractor in order to meet the provisions of the contract with the contractor. Another risk factor with a risk value indicating high risk for S2 is Q5, which indicates that the at least one subcontractor will be providing Check Orders for the contractor, which is an important function for a financial institution. A third risk factor with a risk value indicating high risk for S2 is Q10, indicating that there is a daily exchange of the contractor's information with the at least one subcontractor. The only risk value for S2 that indicates lower risk than any of the S1 risk factors is the answer to Q3, which addresses in which country the work is to be done. Thus, S2 seems to pose much more risk than S1 and may warrant further action to mitigate the risk.

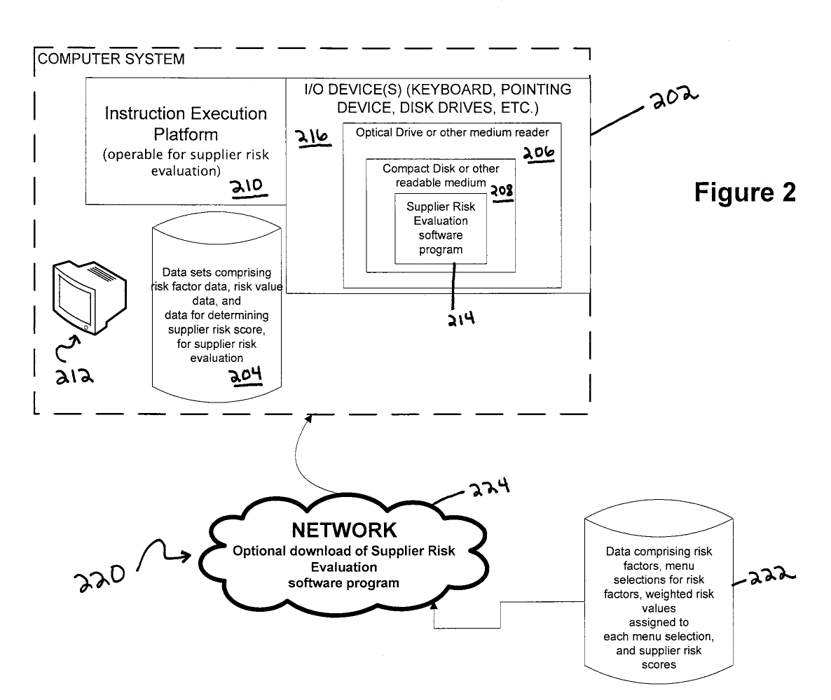

FIG. 2 is a system block diagram according to example embodiments of the invention. FIG. 2 actually illustrates two alternative embodiments of a system implementing the invention. System 202 can be a workstation or personal computer. System 202 can be operated in a “stand-alone” mode. The system includes a fixed storage medium, illustrated graphically at 204, for storing programs and/or macros which enable the use of an embodiment of the invention. In a stand-alone implementation of the invention, fixed storage 204 can also include the data sets which are necessary to implement an embodiment of the invention. In this particular example, the input/output devices 216 include an optical drive 206 connected to the computing platform for loading the appropriate computer program product into system 202 from an optical disk 208. The computer program product includes a computer program or programs with instructions or code for carrying out the methods of the invention. Instruction execution platform 210 of FIG. 2 includes a microprocessor and supporting circuitry and can execute the appropriate instructions and display appropriate screens on display device 212.

FIG. 2 also illustrates another embodiment of the invention in which case the system 220 which is implementing the invention includes a connection to data stores, from which data comprising risk factors, menu selections for risk factors, weighted risk values, and supplier risk scores can be retrieved, as shown at 222. The connection to the data stores or appropriate databases can be formed in part by network 224, which can be an intranet, virtual private network (VPN) connection, local area network (LAN) connection, or any other type of network resources, including the Internet. Data sets can be local, for example on fixed storage 204, or stored on the network, for example in data store 222.

A computer program which implements all or parts of the invention through the use of systems like those illustrated in FIG. 2 can take the form of a computer program product residing on a computer usable or computer readable storage medium. Such a computer program can be an entire application to perform all of the tasks necessary to carry out the invention, or it can be a macro or plug-in which works with an existing general purpose application such as a spreadsheet or database program. Note that the “medium” may also be a stream of information being retrieved when a processing platform or execution system downloads the computer program instructions through the Internet or any other type of network. Computer program instructions which implement the invention can reside on or in any medium that can contain, store, communicate, propagate or transport the program for use by or in connection with any instruction execution system, apparatus, or device. Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or flash memory), a compact disc read-only memory (CD-ROM), or other optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Specific embodiments of an invention are described herein. One of ordinary skill in the computing and/or risk assessment arts will recognize that the invention can be applied in other environments and in other ways. It should also be understood that an implementation of the invention can include features and elements or steps in addition to those described and claimed herein. Thus, the following claims are not intended to limit the scope of the invention to the specific embodiments described herein.

1. A method of evaluating risks posed by a supplier of goods or services, comprising:
identifying a supplier who collaborates with at least one subcontractor or at least one offshore affiliate in providing goods or services under a contract with a contractor;
selecting answer options corresponding to a series of multiple choice questions for measuring risk factors posed by the supplier who collaborates with at least one subcontractor or at least one offshore affiliate in providing goods or services under the contract with the contractor;
calculating a risk score for the supplier based on the answer options selected for the series of multiple choice questions; and
using the risk score to drive mitigation of supplier risk and management of the supplier by the contractor.

2. The method of claim 1, further comprising disaggregating the risk score so that risk values for individual risk factors can be viewed.

3. The method of claim 1, wherein there are at least ten multiple choice questions.

4. The method of claim 1, wherein the answer options for at least some of the multiple choice questions are each assigned a weighted risk value.

5. The method of claim 1, wherein the risk factors measured comprise how the supplier risk is mitigated and how the supplier is managed.

6. The method of claim 5, wherein the risk factors measured comprise at least one of the group consisting of insurance requirement factors, background check factors, audit factors, confidentiality and information protection factors, business continuity factors, and efforts to manage or mitigate risk factors.

7. The method of claim 1, wherein the risk factors measured comprise providing a listing of countries from which is selected each country in which production of goods or services for the contractor will occur.

8. The method of claim 7, wherein each country is assigned a weighted risk value.

9. The method of claim 1, wherein the risk factors measured comprise providing a listing of the goods or services to be provided by the supplier, from which is selected each good or service to be provided by the supplier.

10. The method of claim 9, wherein each good or service is assigned a weighted risk value.

11. The method of claim 9, wherein the risk factors measured comprise a listing of which of the goods or services are to be provided by the at least one subcontractor or the at least one offshore affiliate.

12. The method of claim 11, wherein the risk factors measured comprise a determination of whether the at least one subcontractor or the at least one offshore affiliate is critical to the production of the goods or services provided to the contractor.

13. The method of claim 1, wherein the risk factors measured comprise identifying each subcontractor or offshore affiliate by name.

14. The method of claim 1, wherein the risk factors measured comprise determining whether the at least one subcontractor or the at least one offshore affiliate has access to the contractor's information.

15. The method of claim 1, wherein the risk factors measured comprise determining whether the at least one subcontractor or the at least one offshore affiliate keeps the contractor's information on the at least one subcontractor's or the at least one offshore affiliate's internal information system.

16. The method of claim 1, wherein the risk factors measured comprise determining whether the at least one good or service provided by the at least one subcontractor or the at least one offshore affiliate includes an exchange of the contractor's information with the at least one subcontractor or the at least one offshore affiliate.

17. The method of claim 16, wherein the risk factors measured comprise determining the frequency of the exchange of the contractor's information with the at least one subcontractor or the at least one offshore affiliate.

18. The method of claim 1, wherein the risk factors measured comprise determining whether the at least one subcontractor or the at least one offshore affiliate has connectivity to the contractor's system.

19. The method of claim 1, wherein the risk factors measured comprise determining whether the at least one good or service provided by the at least one subcontractor or the at least one offshore affiliate includes giving/allowing the at least one subcontractor or the at least one offshore affiliate access to the contractor's physical property.

20. The method of claim 19, wherein the risk factors measured comprise determining the frequency of the access to the contractor's physical property by the at least one subcontractor or the at least one offshore affiliate.

21. A computer program product, the computer program product comprising a medium with a computer readable program code embodied therein, the computer readable program code for execution by an instruction execution platform to implement a method of evaluating risks posed by a supplier of goods or services, the method comprising:
identifying a supplier who collaborates with at least one subcontractor or at least one offshore affiliate in providing goods or services under a contract with a contractor;
selecting answer options corresponding to a series of multiple choice questions for measuring risk factors posed by the supplier who collaborates with at least one subcontractor or at least one offshore affiliate in providing goods or services under the contract with the contractor;
calculating a risk score for the supplier based on the answer options selected for the series of multiple choice questions; and
using the risk score to drive mitigation and management of the supplier by the contractor.

22. The computer program product of claim 21, further comprising disaggregating the risk score so that risk values for individual risk factors can be viewed.

23. The computer program product of claim 21, wherein there are at least ten multiple choice questions.

24. The computer program product of claim 21, wherein the answer options for at least some of the multiple choice questions are each assigned a weighted risk value.

25. The computer program product of claim 21, wherein the risk factors measured comprise how the supplier risk is mitigated and how the supplier is managed.

26. The computer program product of claim 25, wherein the risk factors measured comprise at least one of the group consisting of insurance requirement factors, background check factors, audit factors, confidentiality and information protection factors, business continuity factors, and efforts to manage or mitigate risk factors.

27. The computer program product of claim 21, wherein the risk factors measured comprise providing a listing of countries from which is selected each country in which work for the contractor will occur.

28. The computer program product of claim 27, wherein each country is assigned a weighted risk value.

29. The computer program product of claim 21, wherein the risk factors measured comprise providing a listing of the goods or services to be provided by the supplier, from which is selected each good or service to be provided by the supplier.

30. The computer program product of claim 29, wherein each good or service is assigned a weighted risk value.

31. The computer program product of claim 29, wherein the risk factors measured comprise a listing of which of the goods or services are to be provided by the at least one subcontractor or the at least one offshore affiliate.

32. The computer program product of claim 31, wherein the risk factors measured comprise a determination of whether the at least one subcontractor or the at least one offshore affiliate is critical to the production of the goods or services provided to the contractor.

33. The computer program product of claim 21, wherein the risk factors measured comprise identifying each subcontractor or offshore affiliate by name.

34. The computer program product of claim 21, wherein the risk factors measured comprise determining whether the at least one subcontractor or the at least one offshore affiliate has access to the contractor's information.

35. The computer program product of claim 21, wherein the risk factors measured comprise determining whether the at least one subcontractor or the at least one offshore affiliate keeps the contractor's information on the at least one subcontractor's or the at least one offshore affiliate's internal information system.

36. The computer program product of claim 21, wherein the risk factors measured comprise determining whether the at least one good or service provided by the at least one subcontractor or the at least one offshore affiliate includes an exchange of the contractor's information with the at least one subcontractor or the at least one offshore affiliate.

37. The computer program product of claim 36, wherein the risk factors measured comprise determining the frequency of the exchange of the contractor's information with the at least one subcontractor or the at least one offshore affiliate.

38. The computer program product of claim 21, wherein the risk factors measured comprise determining whether the at least one subcontractor or the at least one offshore affiliate have connectivity to the contractor's system.

39. The computer program product of claim 21, wherein the risk factors measured comprise determining whether the at least one good or service provided by the at least one subcontractor or the at least one offshore affiliate includes giving/allowing the at least one subcontractor or the at least one offshore affiliate access to the contractor's physical property.

40. The computer program product of claim 39, wherein the risk factors measured comprise determining the frequency of the access to the contractor's physical property by the at least one subcontractor or the at least one offshore affiliate.

41. A system for evaluating risks posed by a supplier of goods or services comprising:
an instruction execution platform operable to provide risk evaluation of a supplier of goods or services by calculating a supplier risk score; and
a data set comprising risk factors, menu selections for risk factors, weighted risk values, and supplier risk scores, the data set being disposed to be accessed by the instruction execution platform.

42. An apparatus for evaluating risks posed by a supplier of goods or services, the apparatus comprising:
means for identifying a supplier who collaborates with at least one subcontractor or at least one offshore affiliate in providing goods or services under a contract with a contractor;
means for selecting answer options corresponding to a series of multiple choice questions for measuring risk factors posed by the supplier who collaborates with at least one subcontractor or at least one offshore affiliate in providing goods or services under the contract with the contractor;
means for calculating a risk score for the supplier based on the answer options selected for the series of multiple choice questions; and
means for using the risk score to drive mitigation and management of the supplier by the contractor.
